(19) United States
(12) Patent Application Publication
(10) Pub. No.: US 2006/0021290 A1
(43) Pub. Date: Feb. 2, 2006

(54) Sacrificial shield for a window assembly

(76) Inventors: Michael D. Kobrehel, Elkhart, IN (US); Daryl F. Dankert, Mishawaka, IN (US); Leroy C. Schmuck, Kendallville, IN (US); Todd E. Cripe, Goshen, IN (US); Harley Rensch, Corunna, IN (US); Kip B. Ellis, Goshen, IN (US)

Correspondence Address: DURA AUTOMOTIVE SYSTEMS, INC., 2791 RESEARCH DRIVE, ROCHESTER HILLS, MI, 48309, US

(21) Appl. No.: 11/090,934

(22) Filed: Mar. 24, 2005

Related U.S. Application Data
(63) Continuation-in-part of application No. 10/646,468, filed on Aug. 20, 2003.
(60) Provisional application No. 60/651,459, filed on Mar. 29, 2004.
(60) Provisional application No. 60/404,666, filed on Aug. 20, 2002.

(51) Int. Cl. E06B 3/26

(52) U.S. Cl. 52/202

(57) ABSTRACT

Installation structure and method for installing and removing a sacrificial glazing panel. There is also disclosed a flexible sacrificial glazing panel formed of a material, sized and having a thickness to permit flexing of the panel to allow easy removal and seating of the sacrificial glazing panel within a support structure.

### CROSS-REFERENCE TO RELATED APPLICATIONS

The present invention relates to, and is entitled to the benefit of the earlier filing date and priority of: U.S. Provisional patent application Ser. No. 10/812,244 or 60/651,459, filed Mar. 29, 2004, entitled “Sacrificial Shield For A Window Assembly”, U.S. patent application Ser. No. 10/646,468, filed Aug. 20, 2003, and U.S. Provisional Patent Application Ser. No. 60/404,666 filed Aug. 20, 2002, the disclosures of which are hereby incorporated herein by reference.

### FIELD OF THE INVENTION

The present invention relates to window assemblies and apparatus for protecting the primary glazing panel of a vehicle.

### BACKGROUND

Primary glazing panel installations are usually formed of heavy tempered plate glass. The panels are usually sealed around the edges to prevent the entrance of water, dirt, wind, etc. The primary glazing panel installations, especially the ones used in public transportation buses, tend to be expensive and difficult to replace. To protect the primary glazing from vandalism or other damage, replaceable protective glazing panels have been used on the inside of motor vehicles. Examples of sacrificial glazing installations include those described in U.S. Pat. Nos. 5,735,089; 5,809,707; 6,205,723; 6,408,574; 6,688,044, the disclosures of which are incorporated herein by reference.

However, there is a need in the market for low cost sacrificial glazing installations and methods which are simple and fast to perform, that protect the primary glazing, or that tend to be tamper resistant.

### SUMMARY OF INVENTION

Disclosed herein are window assemblies, sacrificial glazing installations, and methods of installing and removing sacrificial glazing panels that can provide low cost sacrificial glazing installations and methods which are simple and fast to perform, that protect the primary glazing, reduce rattling or that tend to be more tamper resistant, which embodiments will be evident from the ensuing disclosure.

In one embodiment the window assembly comprises a frame for mounting to a vehicle; a primary glazing bonded to the frame; a support for holding a sacrificial glazing adjacent the primary glazing, the support having a channel with a lip; a flexible sacrificial glazing panel formed of a material, sized and having a thickness to permit flexing of the panel to removably seat the sacrificial glazing panel within the channel.

In another embodiment, the window assembly comprises a sacrificial glazing that includes a frame having a perimeter channel which is configured to receive a correspondingly configured plastic sacrificial glazing panel. The sacrificial glazing panel is flexible and sized relative to the frame perimeter channel such that upon being bowed to bring a pair of opposite edges together, another edge of the panel is able to be inserted into a receiving channel section. The perimeter channel is preferably deeper in the receiving section to allow substantial vertical (or sideways) movement of the panel once the sacrificial glazing panel is inserted into the frame perimeter channel in order that an opposite glazing panel will clear the edge lip portion of the associated channel section.

In another embodiment, the window assembly comprises a sacrificial glazing assembly having a support and a sacrificial window panel positioned in the support and a resiliently compressible element(s) for biasing the sacrificial panel in the support. The resiliently compressible element may be disposed in a bottom of a panel receiving channel section in the support.

The resiliently compressible element may act as a positioner element that allows an installed sacrificial glazing panel to be repositioned after initial installation so as to locate the inserted panel edge well within a retainer lip of a receiving channel section of a support. In a preferred embodiment, forcible movement of an inserted edge of a sacrificial glazing panel against a compressible positioner element allows the panel to be moved past an equilibrium position. Further application of a force on the panel allows an opposite edge of the panel to be moved into the retainer lip. Upon release of the force, the positioner element will move the sacrificial glazing panel to an equilibrium position which in turn may seat the opposite edge of the panel in the opposite channel section. Removal of the sacrificial panel is enabled upon a subsequent outward bowing thereof which draws the pair of opposite panel edges together sufficiently to clear lip portions of an associated pair of channel sections, so that the panel can be titled and lifted out of the frame.

The resiliently compressible positioner element may be any suitable device, including a wave spring, compressible foam strip(s), compressible elastomeric seal(s) or spring(s) and slider assemblies, etc.

In an alternative embodiment, the sacrificial glazing panel may be suspended in the panel support. In one embodiment, the sacrificial glazing panel is suspended by removable plugs inserted into the lip of a lower channel section. The lower channel may be a deeper receiving channel section than an opposing channel. A bottom edge of the sacrificial glazing panel may be rested on the plugs to hold the panel in an elevated position in the lower channel so that the top edge is retained by the lip of the top channel section. Removal of the plugs allows the sacrificial glazing panel to be lowered sufficiently so that the upper edge clears the top channel section lip portion, in preparation for removal of the panel.

In another embodiment, the deeper channel section is in the top channel section to eliminate the need for positioner elements.

In still another embodiment, a foamed elastomer is inserted into one or more channels of the support to hold and isolate the sacrificial glazing panel in the retainer.

### DESCRIPTION OF THE DRAWINGS

FIG. 1 is a vertical sectional view of a window having upper and lower glazing assemblies each including a sacrificial glazing panel installation according to the invention.

FIG. 2 is a front view of the window shown in FIG. 1.

FIG. 3 is a fragmentary sectional view of a horizontal section taken through the window shown in FIG. 2

FIG. 4 is a fragmentary sectional view of an alternate embodiment of a sacrificial glazing panel installation.

FIG. 5 is a fragmentary section view of a second alternate embodiment of a sacrificial glazing panel installation.

FIG. 6 is a fragmentary section view of a third alternate embodiment of a sacrificial glazing panel installation.

FIG. 7 is a fragmentary section view of a fourth alternate embodiment of a sacrificial glazing panel installation.

FIG. 8 is a view of the sacrificial glazing panel installation show in FIG. 7, but with the positioner plugs removed.

FIG. 9 is a front view of a window having sideways movable glazing panels incorporating a sacrificial glazing panel installation.

FIG. 10 is a view of the section 10-10 taken in FIG. 9.

FIG. 11 is a view of the section 11-11 taken in FIG. 9.

FIG. 12A is a fragmentary section view of a fifth alternate embodiment of a sacrificial glazing panel during installation in a receiving channel section.

FIG. 12B is a fragmentary section view of a fifth alternate embodiment of a sacrificial glazing panel installed in a receiving channel section.

FIG. 13 is a fragmentary section view of a sixth alternate embodiment of a sacrificial glazing panel installation.

FIG. 14 is a load-displacement relationship for a foamed elastomer.

### DETAILED DESCRIPTION OF PREFERRED EMBODIMENTS

In the following description, certain specific terminology will be employed for the sake of clarity and a particular embodiment described in accordance with the requirements of 35 USC 112, but it is to be understood that the same is not intended to be limiting and should not be so constructed in as much as the invention is capable of taking many forms and variations within the scope of the appended claims.

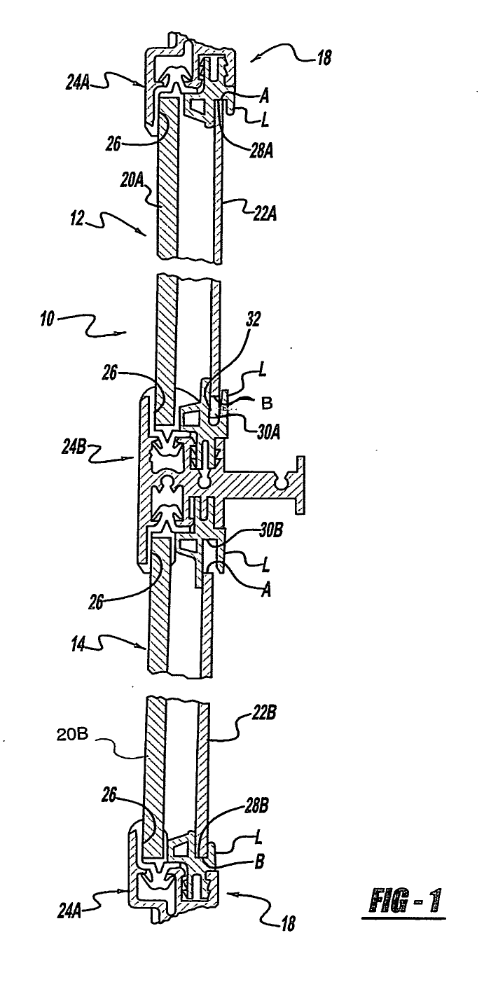

Referring to the drawings, and particularly to FIGS. 1-3, depicted therein is a vehicle window assembly 10 which includes an upper glazing assembly 12 and a lower glazing assembly 14 for mounting in a vehicle body. The primary glazing may be bonded to the frame or compressed fit therein with a frame and seal assembly 18. If bonded, the primary glazing may be bonded by any suitable method, such as adhesives, molded together, etc. A bonded primary glazing offers advantages in certain applications. The primary glazing may be flush mounted. The frame may be made of any suitable material, such as metal or a polymer. The frame may be aluminum. Primary glazing panels may be constructed of any suitable material, such as tempered glass, laminated glass, acrylic, polycarbonate, etc.

As shown, the window assembly includes two window sections each having a primary glazing panel 20A, 20B, and associated seals carried in respective retainer frames. Although the description is to a multi-window assembly, the window assembly may also be modified to be a single window assembly.

The window assembly as shown includes a retainer perimeter frame section 24A and straight mullion frame sections 24B, each defining perimeter channels 26 for receiving the primary glazing panels 20A, 20B.

The retainer frame sections 24A, 24B may also be used to mount sacrificial glazing panels 22A, 22B. Each sacrificial glazing panel 22A, 22B has a top, bottom and side edges A, B, C, D, each edge may be received in an associated perimeter channel section defined by a respective retainer section 24A and 24B. The retainer frame sections act as one type of support for the sacrificial glazing panels.

Upper channels 28A, 28B and lower channels 30A, 30B are formed in part by outer lip portions L which define a glazing opening smaller in size than the size of the sacrificial glazing panels 22A, 22B.

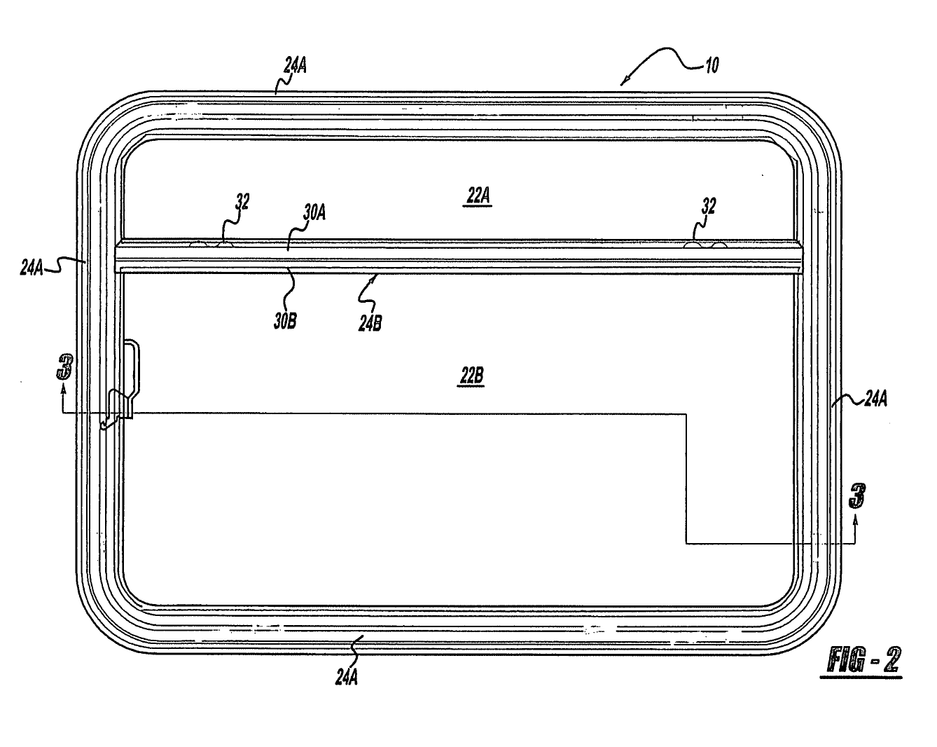

The upper mullion channel section 30A has an elastomeric member installed in the bottom. As shown in FIG. 2, the elastomeric member is a pair of double bowed leaf springs 32. The leaf springs act as a biasing member that allows the repositioning of the lower edge B of sacrificial glazing panel 22A at an intermediate position in the channel section 28A after downward pressure of the glazing panel 22A has been released. Repositioning allows the top edge A of the panel to be raised to a location within the channel lip L to securely retain the glazing in the channel section 28A.

The sacrificial glazing panels 22A, 22B are preferably flexible. A flexible glazing panel may be constructed of relatively thin material, (such as less than one half inch, and more preferably ⅛^{th} inch plus or minus 7/64^{th}). Suitable materials include plastic, polycarbonate, acrylic, etc. The panel is preferably of a size greater than the opening defined by the retaining lips L, but of a size smaller than a diameter defined by the support or channels. The sacrificial glazing panel is preferably of a size such that when the center of the panel 22A, 22B is bowed, as with the use of a pair of handled suction cups, the side edges C, D can be drawn in to allow one edge to be removed or inserted from or into a receiving channel section, such as channel section 30A or 30B.

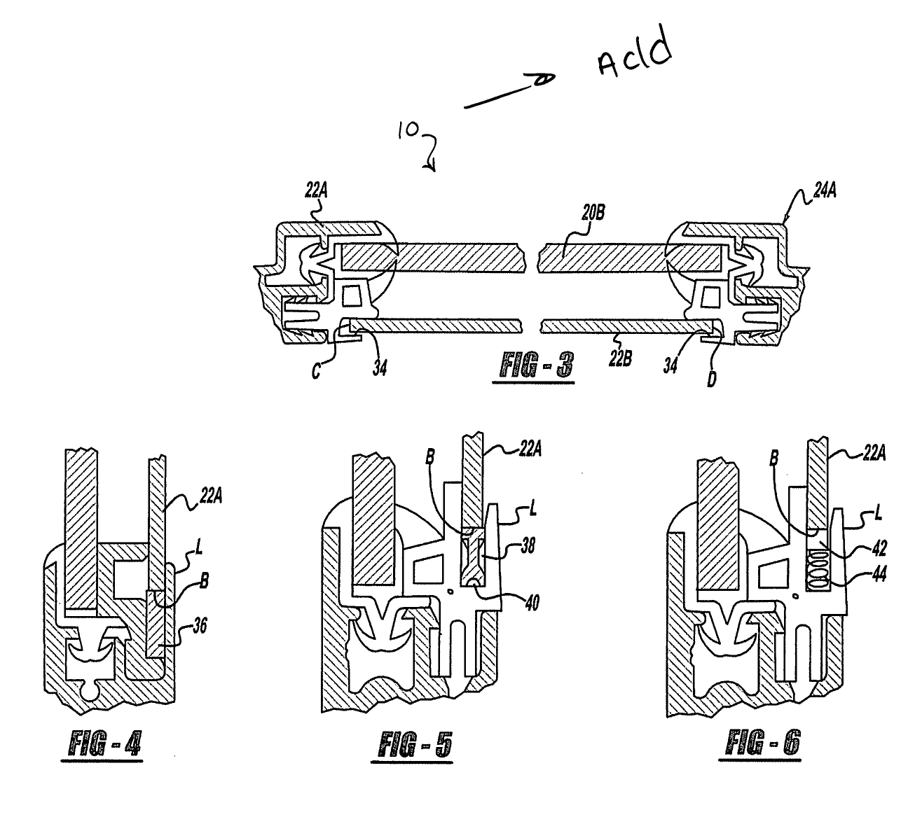

The top and bottom channel sections 28A, 28B may be shallower then the opposing mullion channels 30A, 30B so that when one edge of the sacrificial glazing panel 22A or 22B is first inserted and moved sufficiently towards the bottom of the respective channel 30A, 30B the opposite edge clears the lip L of the respective channel section 28A, 28B to allow the glazing panel 22A or 22B to be completely moved into the frame. Upon release, the side edges C, D of the sacrificial glazing panel 22A, 22B move apart to be received and retained in the associated side channels 34 (FIG. 3) of the perimeter frame sections 24A and 24B.

To remove a sacrificial glazing panel 22A, the glazing panel may be forcibly pressed downward to compress the double bowed leaf springs 32, moving the top edge A down sufficiently to clear the lip L of the associated channel section 28A. The sacrificial glazing panel 22A may also be bowed to draw together side edges C, D to clear lip L of the side channel 34 and allow the sacrificial glazing panel 22A to be titled and lifted out.

The bottom edge B of the lower sacrificial glazing panel 22B, as shown, is gravity biased down into the channel section 28B, and then panel 22B thus need only be lifted up until the bottom edge clears the associated channel section lip L and the panel 22A is then bowed to allow titling out and removal. Thus, a positioner element may not be necessary to retain the top edge.

FIG. 4 shows an arrangement of one or more compressible foam pieces 36 positioned to engage the lower edge B of an upper sacrificial glazing panel 22A to hold the same in a channel of a sacrificial glazing panel support formed by a lip L.

FIG. 5 shows a compressible elastomeric element 38 which has a space 40 allowing downward movement when removing the sacrificial glazing panel 22A from lip L.

FIG. 6 shows a slide 42 and compression spring 44 engaging the underside of the slide 42 to urge the same up to position the upper edge of the sacrificial glazing panel 22A within an upper channel section.

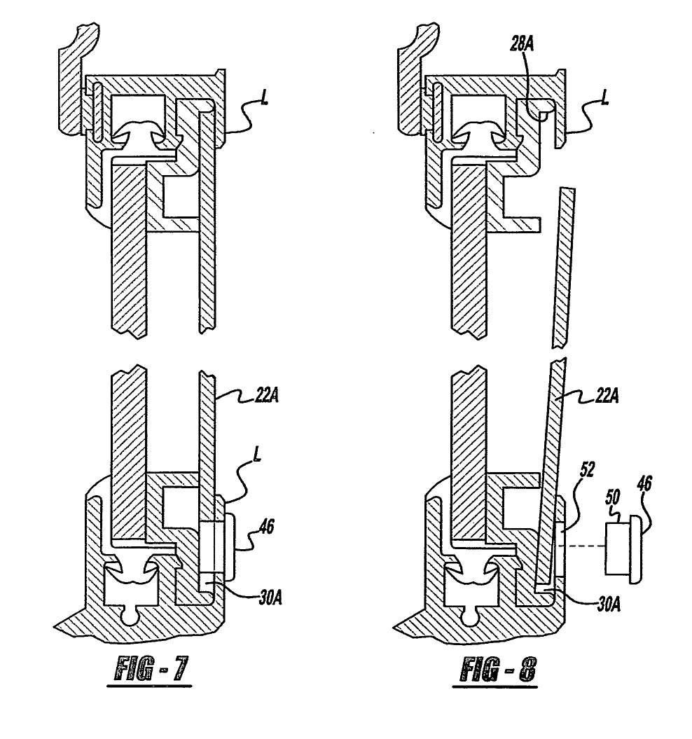

FIGS. 7 and 8 show an arrangement comprised of a series of removable headed plugs 46 insertable in the lip L of the lower channel 30A. The plugs 46 may each have a stem 50 for protruding through an opening 52 and into the channel 30A of a frame or lip to hold the sacrificial glazing panel 22A in an up or seated position.

Upon removal of the plugs 46, the sacrificial glazing panel 22A is lowered sufficiently to clear the lip L of the upper channel 28A, so that upon bowing of the panel 22A, it may be titled out of removed as described above.

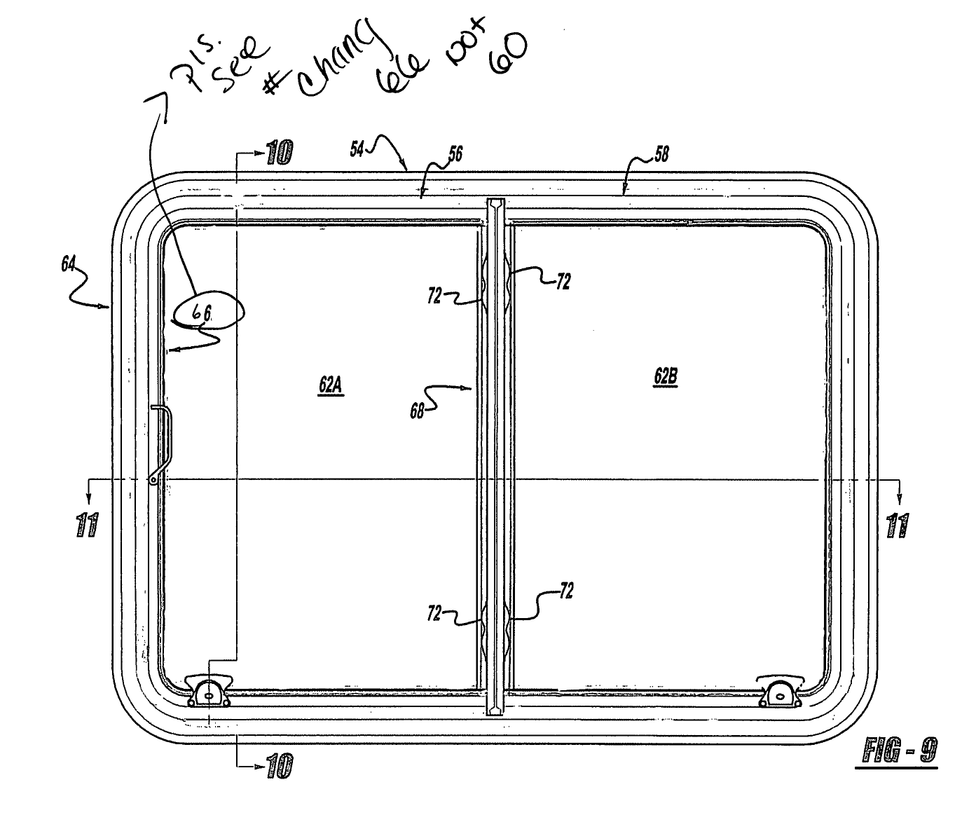

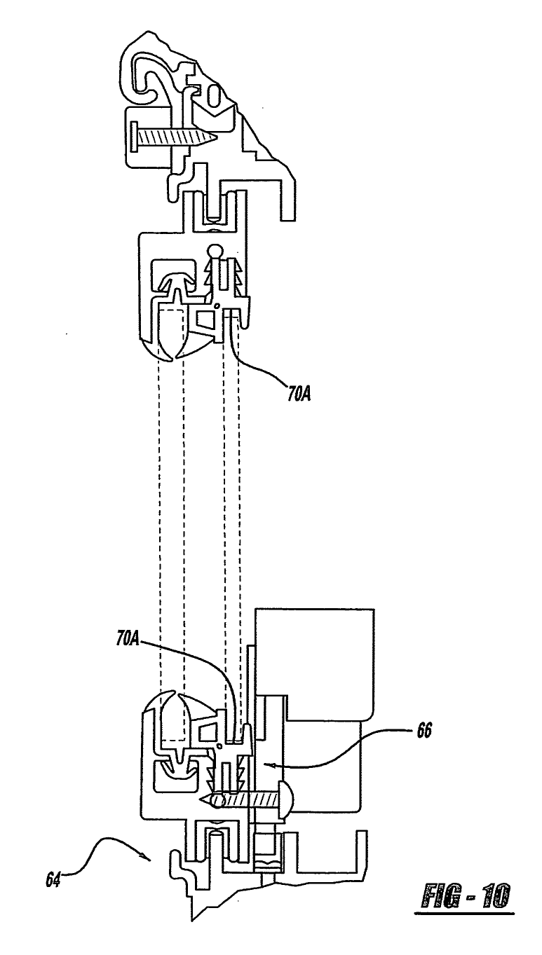

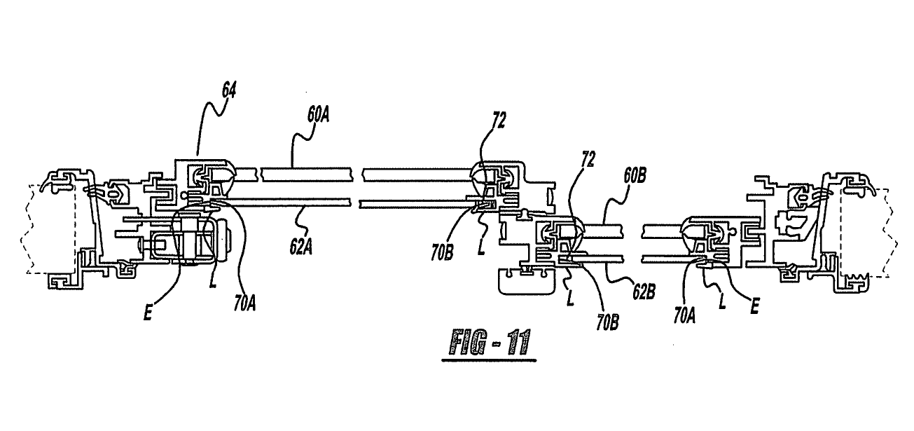

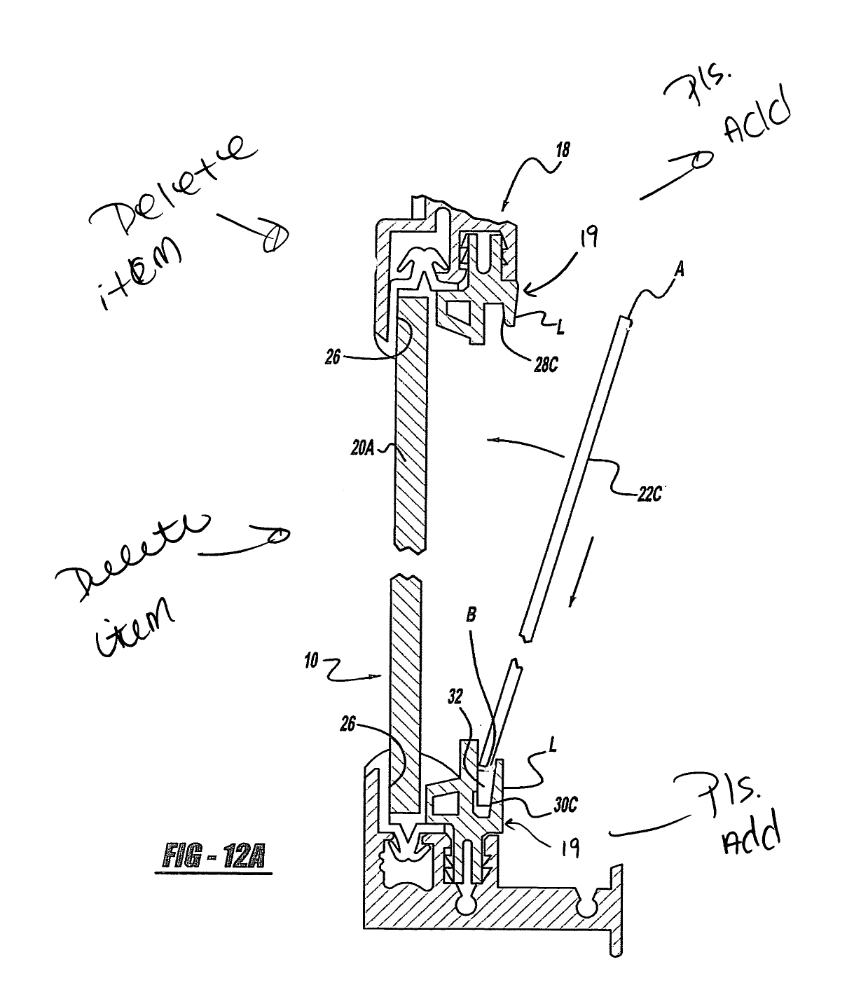

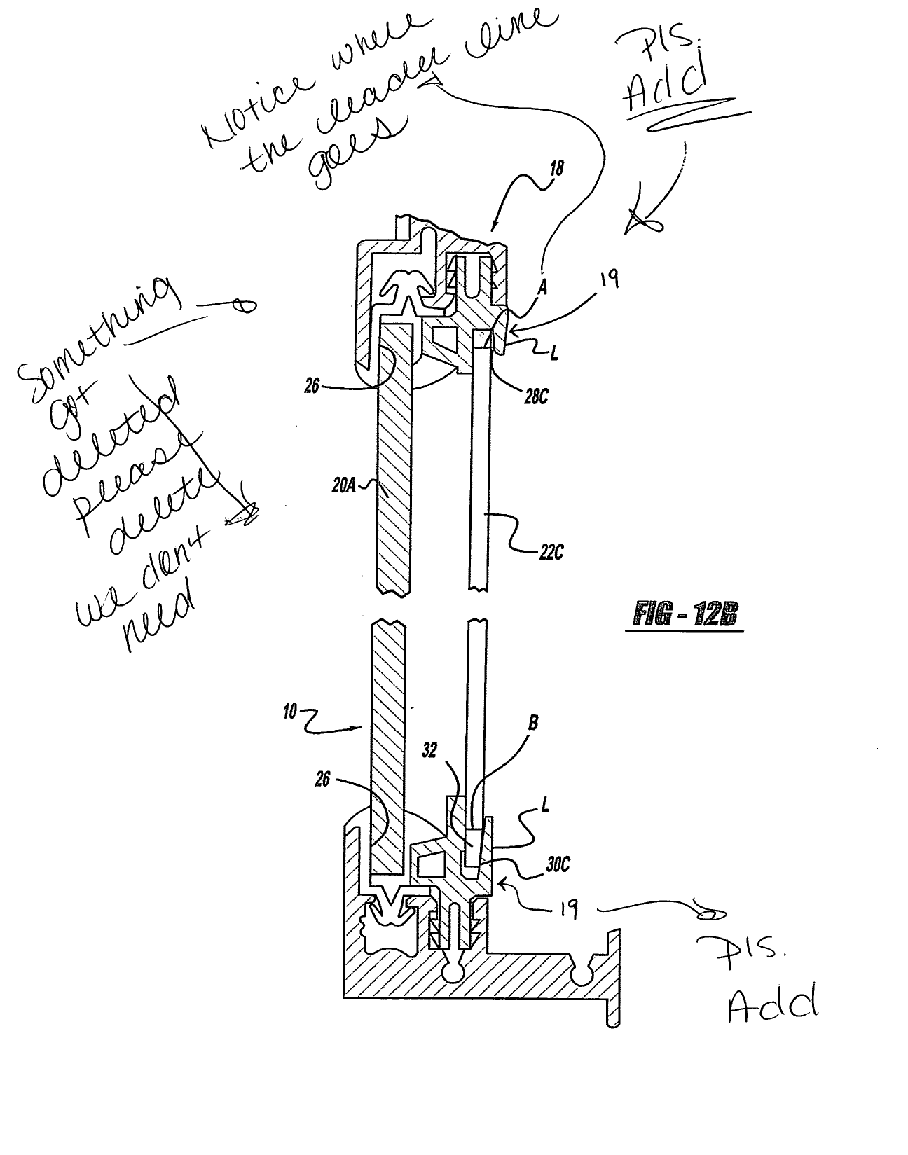

The glazing panels may also be shifted sideways in the frame for removal. FIG. 9-11 show a window assembly 54 comprised of a pair of side glazing assemblies 56 and 58, each mounted in a frame and seal assembly 64. Each glazing assembly 56, 58 includes a primary glazing panel 60A, 60B and sacrificial glazing panel 62A, 62B mounted in a retainer frame as in the above described embodiments.

A curved corner generally rectangular perimeter frame section 66 and a straight divider frame section 68 respectively define sacrificial glazing panel receiving channel sections 70A, 70B. The vertical divider channel section 70B is deeper than the opposing perimeter channel sections 70A to allow horizontal shifting movement of the sacrificial glazing panel 62A, 62B during installation and removal as described above, instead of the vertical movement described above.

The divider channel section 70B receives at least one double bowed leaf spring 72, which may be disposed against the bottom thereof. There may be a pair of springs 72 normally position to bias one side edge of the sacrificial glazing panels 62A, 62B so as to be retained by the lip L of the opposite section of the perimeter channel sections 70A in a similar fashion to the above described embodiment.

Thus, in practice, sacrificial glazing panels 62A, 62B can be shifted sideways by compressing the double bowed leaf springs 72 to allow the side edge E to clear the lip L. Upon bowing the sacrificial glazing panels 62A, 62B the top and bottom edges are drawn together to clear the lip L of the top and bottom perimeter channel sections 70A to enable tilting out and removal of the sacrificial glazing panels 62A or 62B. Installation may be carried out in a complementary fashion.

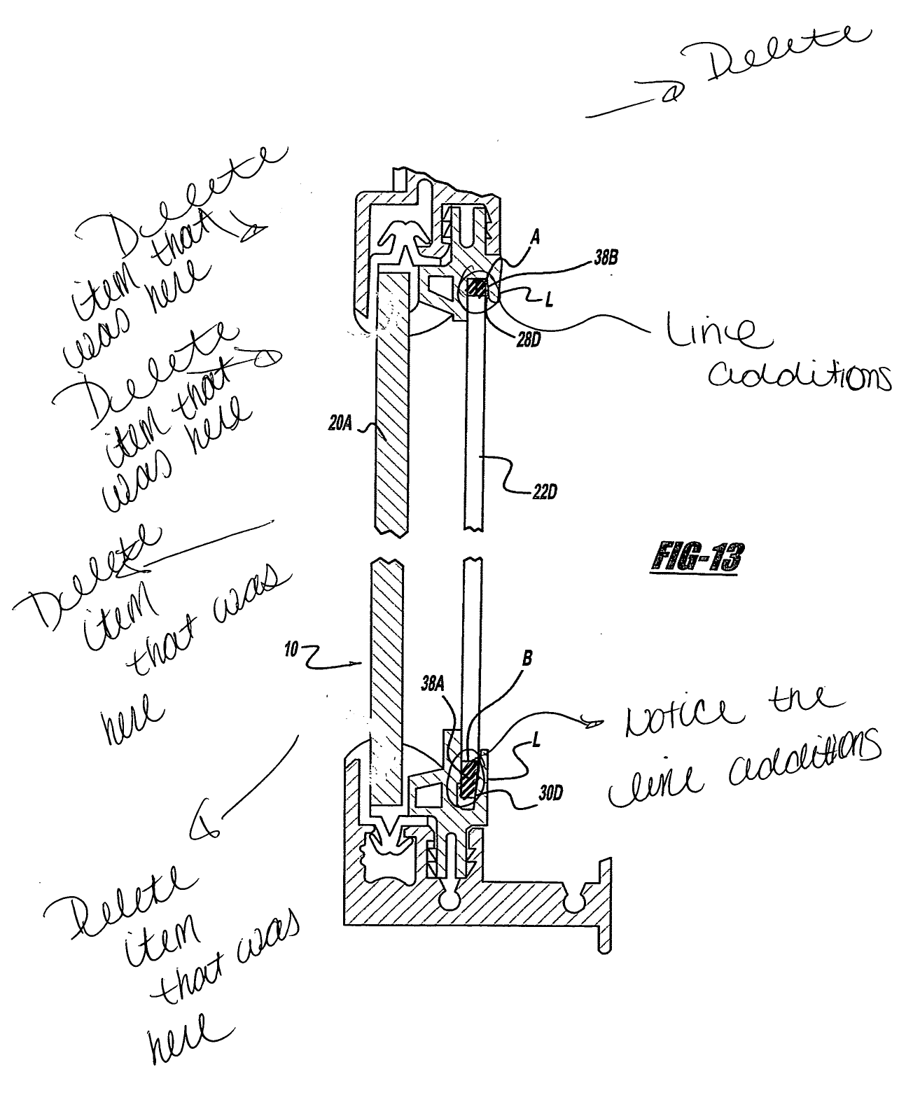

FIGS. 12A-12B show an arrangement of a window assembly 10 having a primary glazing 22A supported in a frame 18 against seals 26. The window assembly 10 has a sacrificial glazing assembly disposed adjacent to the primary glazing assembly, which as shown is connected to the frame of the primary glazing assembly. The sacrificial glazing assembly has a sacrificial glazing panel support 19. The sacrificial glazing panel support 19 has a first channel 28C and an opposing second channel 30C which allows the edge B of the sacrificial glazing panel 22C to first be inserted into the second channel 30C and then moved sufficiently in the second channel 30C to allow the second edge A of panel 22C to clear the lip L of the channel section 28C and allow the sacrificial glazing panel 22C to be completely moved into and retained between the first and second channels 28C and 30C as shown in FIG. 12B. Once the edge B of panel 22C clears the lip L, and the edge A of panel 22C clears the lip L, the bottom edge rests on elastomeric element 33 in the bottom of one channel but does not rest on the actual bottom surface of the channel.

The insertion of the sacrificial glazing may be aided by a flexible panel and bowing of this panel. Upon release of the bowing of the glazing panel 22C, the side edges C, D of the sacrificial glazing panel 22C move apart to be received and retained in the associated side channels of the perimeter frame sections 24C. In this position, the panel 22C is supported by the elastomeric element 33 in the bottom channel 30C, which may move up and down in response to inertia, gravitational forces and other forces experienced by the mass transit vehicle during its normal operation, but edges of panel 22C do not touch the bottom or top surface of the channels.

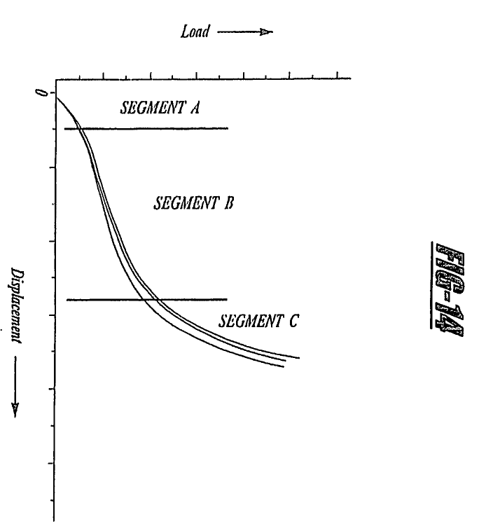

FIG. 13 shows an embodiment of a window assembly 10 with a primary glazing 20A and a sacrificial glazing assembly disposed adjacent to the primary glazing. In this case the resiliently compressible positioner element includes a compressible foam elastomeric element 38A. The compressible foam elastomeric element may be inserted into a top channel, side channel, bottom channel or any combination of the above. As shown, a compressible foam elastomeric element 38B is inserted in a top channel 28D and an opposing bottom channel 30D. The foam elements 38A and 38B are highly compliant but resilient, and preferably fill their respective channels.

The foamed elastomeric elements 38A, 38B are preferably made of highly compliant material, such as micro cellular polyurethane (MCU), etc. A highly compliant material is desired since the sacrificial glazing must be easily installed, yet held in place in the top channel 28C and bottom channel 30C. A highly compliant material is also desired since it can dampen vibrations transmitted to the glazing panel by operation of the vehicle. Alternatively, the foamed elastomeric material may be selected from fluoracarbon, highly saturated nitrile (HBNR), methyl acrylate acid polymer, silicone, EPDM, Neoprene.RTM, natural rubber, plyisoprene or any suitable thermoset elastomer or thermoplastic or optionally any other elastomeric foamed material suitable for the application, including plastomers and thermoplastics.

Foamed micro cellular polyurethane is a polymer product obtained from the interaction of the die-isocyanate glycol and a blowing agent. The glycol may be a polyol that can be either the polyester or polyether type. Both types generally have hydroxyl groups that are free to react with the di-isocyanate. The isocyanate reacts with water to produce carbon dioxide gas for foaming. Foam density may be determined by the quantity of water present in the formulation and may be characterized by the weight of the polyurethane material divided by the overall volume of the part. Once intimately mixed, the ingredients are discharged from a mixer and deposited into a mold or an extruder where the complex chemical reactions take place to form the micro cellular polyurethane.

The chemical reactions are primarily exo-thermic which convert the liquid into a foam. This technology is generally known in the prior art. See Rubber Technology, Third Edition, edit by the Maurice Morton-Van Norstand Reinhold, ISBN 0-422-2642204, pages 555-560, which is incorporated by reference herein. The damping characteristics of a micro cellular polyurethane foam are adjusted by the amount of gases trapped in the body of the polyurethane. Thus, the stiffness, and the vibration characteristics of the micro cellular polyurethane can be adjusted by varying MCU density to meet specific application requirements. Micro cellular polyurethane foam density varies from 0.3 to 0.8 grams per cubic centimeter. The characteristics of MCU or foamed elastomers, as compared to solid rubber, are primarily influenced by the micro cellular structure of the material and not by the chemical backbone or primary polymeric material. Due to the micro cellular nature of the MCU material, polyurethane cells will collapse on to each other under a compressing load.

As stated previously, the micro cellular polyurethane has a cell like structure that includes cell unites filled with gases such as air. When the micro cellular polyurethane is compressed, the cell structures tend to collapse and push the air out of the cells. This material behavior results in a more gradual absorption of sudden load changes, hence a more gradual load absorption, as shown in FIG. 14.

As a load on the elastomeric member increases from a no-load condition, the stiffness as shown in Segment A in FIG. 14, increases. With further increases in load, the stiffness flattens somewhat as shown in Segment B. This is the “soft” segment where the micro cellular cells of the MCU begin to collapse upon themselves. As the load increases even further and the cells are substantially collapsed upon themselves, the stiffness increases as shown in Segment C in FIG. 14. Those skilled in the art will recognize that the curve shown in FIG. 14 is representative of the general stiffness response to load and displacement for MCU material with an MCU density of 0.3 to 0.8 per cubic centimeter.

In practice, the glazing panel 22D is inserted into the bottom channel 30D and moved into contact with the foamed elastomeric element 38A. The element 38A is designed so that when the glazing panel is pressed into the foamed element 38A, the force and weight of the panel causes the cells to collapse so as to operate in Segment C of FIG. 14. Panel 22D is then moved adjacent to the lip L of the top channel 28D. Next panel 22D is moved into the top channel 28C, then moved into contact with the foamed elastomeric element 38B. After panel 22D is pressed into the foamed element 38A and panel 22D is released, a biasing force from the foamed elastomeric element 38A presses the opposite edge of panel 22D into the foamed element 38B so that the panel compresses the cells in the element 38B and the foamed element 38B operates in Segment C in FIG. 14. The elastomeric elements may have different elastomeric properties, such as stiffness or resiliency. For example, the bottom elastomeric element may have a greater rebound force than the upper elastomeric element. Those skilled in the art recognize that foamed elastomeric element 38A can also be made to operate in Segment B in FIG. 14 depending on the depth of the channel and the weight of the panel so long as the foamed elastomeric element 38B operates in Segment C in FIG. 14. Thus, a simple and quick installation or removal of sacrificial glazing panels can be performed with a minimum use of tools.

Claim terms should be interpreted as generally understood by one skilled in the art at the time of filing unless expressly defined otherwise. Order of steps in method claims can be done in any reasonable order and therefore should not be given significance unless specifically stated.

1. A window assembly for a vehicle comprising:
a frame for mounting to a vehicle;
a primary glazing, the primary glazing bonded to the frame;
a support for holding a sacrificial glazing adjacent the primary glazing, the support having a channel with a lip;
a flexible sacrificial glazing panel formed of a material, sized and having a thickness to permit flexing of the panel to removably seat the sacrificial glazing panel within the channel.

2. The window assembly of claim 1, wherein the primary glazing is flush mounted in the frame.

3. The window assembly of claim 1, wherein the flexible sacrificial glazing panel is less than one half of an inch in thickness.

4. The window assembly of claim 1, wherein the flexible sacrificial glazing panel is one eight of an inch thick plus or minus 7/64 of an inch.

5. The window assembly of claim 1, wherein the support for holding a sacrificial glazing is bonded with the frame.

6. The window assembly of claim 1, wherein the frame is aluminum.

7. The window assembly of claim 1, wherein the channel has a bottom section and the window assembly further comprises a first foamed elastomeric member disposed in the bottom section.

8. The window assembly of claim 7, wherein the channel has a top section and the window assembly further comprises a second foamed elastomeric member disposed in the top section.

9. The window assembly of claim 1, wherein the channel has a first side section and the window assembly further comprises a first foamed elastomeric member disposed in the first side section.

10. The window assembly of claim 9, wherein the channel has a second side section and the window assembly further comprises a second foamed elastomeric member disposed in the second side section.

11. A glazing panel installation comprising, in combination:
a glazing panel having a first edge, a second edge and a pair of side edges;
a retainer frame defined by sections of a perimeter channel forming a glazing opening for receiving the edges of the panel, the sections of the perimeter channel each having a lip together defining an opening of smaller size that the glazing opening, the perimeter channel forming a receiving channel section and an opposite channel section, to retain the panel therein;
a first foamed elastomeric member disposed in the receiving channel section;
a second foamed elastomeric member disposed in the opposite channel section, the first and second foamed elastomers each having a load-displacement relationship including a first section, a second section and a third section, the third section being harder then the first section and second section, the first section being softer then the second section and the third section; and
said glazing panel being sufficiently flexible so as to be bowed to allow opposite edges to be drawn together sufficiently to be able to be passed by the lips of opposite sections of the perimeter channel and allow the one edge of the glazing panel to be inserted in the opposite channel section, the first edge of the glazing compressing the first foamed elastomeric member so that the load-displacement relationship is in the third section and creating a biasing force so that the second edge of the glazing is compressed in the second foamed elastomeric member, so that the load-displacement relationship of the second foamed elastomer member is in the third section to secure the glazing panel to the frame and reduce vibration.

12. A method of installing and removing a glazing panel having a first, second and a pair of side edges corresponding to a frame defining a glazing opening, the frame having a perimeter channel having a first, second and a pair of side sections each formed with a lip and adapted to receive and retain the glazing panel therein and a recessed surface, the perimeter channel retaining the glazing panel therein, the method including the steps of:
flexing the glazing in an amount sufficient bow the panel to draw opposite edges to together sufficiently to be able to be passed by the lips of opposite sections of the perimeter channel;
positioning the first edge of the glazing panel past the lip of the perimeter channel such that the first edge is disposed adjacent but spaced away from the recessed surface;
moving the second edge of the glazing panel inward past the lip of the perimeter channel and into a void defined by the perimeter channel;
unflexing the glazing; and
positioning the first edge to rest on a recessed surface.
